(19) United States
(12) Patent Application Publication
(10) Pub. No.: US 2016/0248694 A1
(43) Pub. Date: Aug. 25, 2016

(54) COMMUNICATION APPARATUS, COMMUNICATION SYSTEM, AND COMMUNICATION METHOD

(71) Applicant: FUJITSU LIMITED, Kawasaki-shi (JP)

(72) Inventors: Hiroshi Yanagita, Kawasaki (JP); Hidenori Takai, Yokohama (JP)

(73) Assignee: FUJITSU LIMITED, Kawasaki-shi (JP)

(21) Appl. No.: 15/046,925

(22) Filed: Feb. 18, 2016

(30) Foreign Application Priority Data
Feb. 23, 2015 (JP) 2015-032860

(51) Int. Cl. H04L 12/911; H04L 12/26

(52) U.S. Cl. CPC H04L 47/72; H04L 43/0894

(57) ABSTRACT

A communication apparatus includes a memory, and a processor coupled to the memory and configured to calculate, based on a bandwidth variation tendency of a calculated network bandwidth between the communication apparatus and other communication apparatus, a usable network bandwidth at a transmission time at which the other communication apparatus transmits data, determine, based on the usable network bandwidth, a size of the data to be transmitted, inform the other communication apparatus of the size of the data, and receive the data of the size from the other communication apparatus at the transmission time.

### CROSS-REFERENCE TO RELATED APPLICATION

This application is based upon and claims the benefit of priority of the prior Japanese Patent Application No. 2015-032860, filed on Feb. 23, 2015, the entire contents of which are incorporated herein by reference.

### FIELD

The embodiment discussed herein is related to a communication apparatus, a communication system, and a communication method.

### BACKGROUND

In recent years, for example, as the number of Internet users increase, as communication speeds in communication networks are improved, and as smartphones and tablets become widespread, an increase in the size of data to be transmitted and received, the immediacy of streaming, and so forth have been demanded.

Incidentally, in the case where communication is carried out between a server and a client, transmission and reception has hitherto been performed with a predetermined data size regardless of a network environment. Hence, for example, when a predetermined data size is 800 Mbit, communication is carried out ten times before the transmission and reception of a file of 1 GB is completed. The related art is disclosed in Japanese Laid-open Patent Publication No. 2001-53805.

### SUMMARY

According to an aspect of the invention, a communication apparatus includes a memory, and a processor coupled to the memory and configured to calculate, based on a bandwidth variation tendency of a calculated network bandwidth between the communication apparatus and other communication apparatus, a usable network bandwidth at a transmission time at which the other communication apparatus transmits data, determine, based on the usable network bandwidth, a size of the data to be transmitted, inform the other communication apparatus of the size of the data, and receive the data of the size from the other communication apparatus at the transmission time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication system;

FIG. 2 illustrates an example of a hardware configuration of a communication terminal;

FIG. 3 illustrates functions of the communication terminal;

FIG. 4 is a flowchart illustrating operations performed by the communication terminal;

FIG. 5 illustrates an example of a data table;

FIG. 6 illustrates variations in usable network bandwidth;

FIG. 7 illustrates a comparative example for illustrating the effect of the embodiment; and

FIG. 8 illustrates the effect of the embodiment.

### DESCRIPTION OF EMBODIMENT

In the above-described existing technique, communication is carried out with a predetermined data size without regard to a network environment, and thus, for example, in the case where a usable network bandwidth is less than the predetermined data size, congestion occurs and has adverse effects on other communication. Furthermore, in the existing technique, for example, even in the case where a usable network bandwidth is not less than the predetermined data size, efficient communication is not able to be carried out fast.

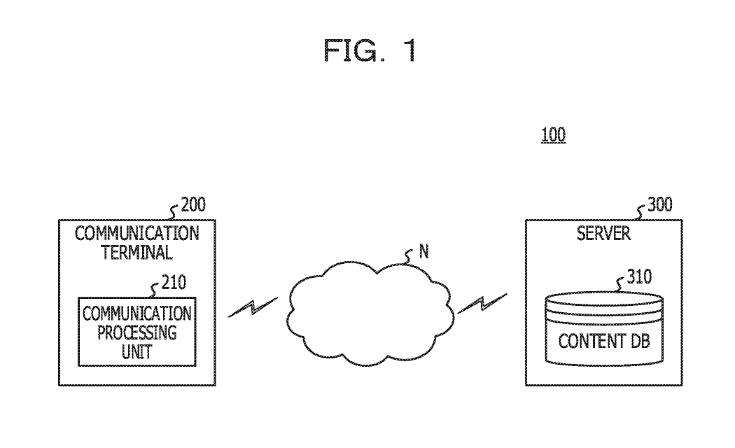

An embodiment will be described below with reference to the drawings. FIG. 1 illustrates an example of a communication system.

A communication system 100 of the embodiment includes a communication terminal 200 and a server 300. The communication terminal 200 and the server 300 of the embodiment are coupled to each other via, for example, a communication network N, or the like.

The communication terminal 200 of the embodiment includes a communication processing unit 210, and communicates with the server 300. The server 300 includes a content database 310.

When the communication terminal 200 accepts an acquisition request for data, the communication terminal 200 makes an acquisition request for data to the server 300, and receives (downloads) the data from the server 300. Furthermore, when the communication terminal 200 accepts a data transmission request to the server 300, the communication terminal 200 transmits (uploads) data to the server 300.

When the transmission and reception of data is performed, the communication terminal 200 of the embodiment transmits packet Internet groper (ping) data to the server 300 to obtain response times, and calculates a usable network bandwidth based on the response times, by using the communication processing unit 210. Then, the communication terminal 200 estimates a variation tendency of the calculated network bandwidth, and provides a notification of a data size responsive to an estimation result to the server 300 together with an acquisition request for data. The server 300 receives the notification, and transmits data of a requested data size to the communication terminal 200.

In the communication system 100 of the embodiment, as described above, a usable network bandwidth is estimated, and a data size in transmission and reception is decided on, therefore enabling communication with an optimal data size and an improvement in communication efficiency.

It is noted that the communication system 100 in FIG. 1 includes, but is not limited to, one server 300. The communication system 100 may include a certain number of servers.

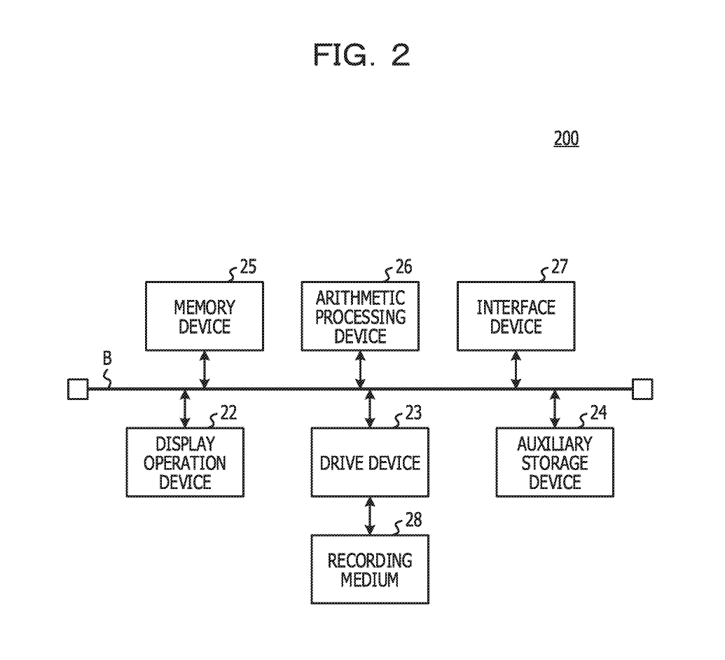

The communication terminal 200 of the embodiment will be described below. FIG. 2 illustrates an example of a hardware configuration of the communication terminal.

The communication terminal 200 of the embodiment includes a display operation device 22, a drive device 23, an auxiliary storage device 24, a memory device 25, an arithmetic processing device 26, and an interface device 27 which are coupled to one another via a bus B.

The display operation device 22 is a device used for input and output of various pieces of information, and is a touch panel or the like having a display function, for example. The interface device 27 includes a modem, a local area network (LAN) card, and so forth, and is used to couple the communication terminal 200 to a network.

Communication programs are at least some of various programs that control the communication terminal 200. A communication program is provided by, for example, distribution of a recording medium 28, or downloading from a network. As the recording medium 28 storing a communication program, there may be used various types of recording media. Examples of various types of recording media include a recording medium, such as a compact disc-read only memory (CD-ROM), flexible disk, or magnetic optical disk, that optically, electrically, or magnetically records information, and a semiconductor memory, such as a read only memory (ROM) or flash memory, that electrically records information.

Furthermore, when the recording medium 28 storing a communication program is inserted into the drive device 23, the communication program is installed from the recording medium 28 onto the auxiliary storage device 24 via the drive device 23. A communication program downloaded from the network is installed onto the auxiliary storage device 24 via the interface device 27.

The auxiliary storage device 24 stores the installed communication programs, and also stores files, data, and the like to be used. When a computer is booted up, the memory device 25 reads the communication programs from the auxiliary storage device 24 and stores them. Then, the arithmetic processing device 26 implements various operations like those to be described in accordance with each program stored in the memory device 25.

It is noted that, in the case where the communication terminal 200 of the embodiment is a typical computer, the communication terminal 200 may include an input device and an output device in place of the display operation device 22. Examples of an input device include a keyboard and a mouse. An example of an output device is a display.

Furthermore, the server 300 of the embodiment is, for example, a typical computer, and has the same configuration as that illustrated in FIG. 2, and description thereof is therefore omitted.

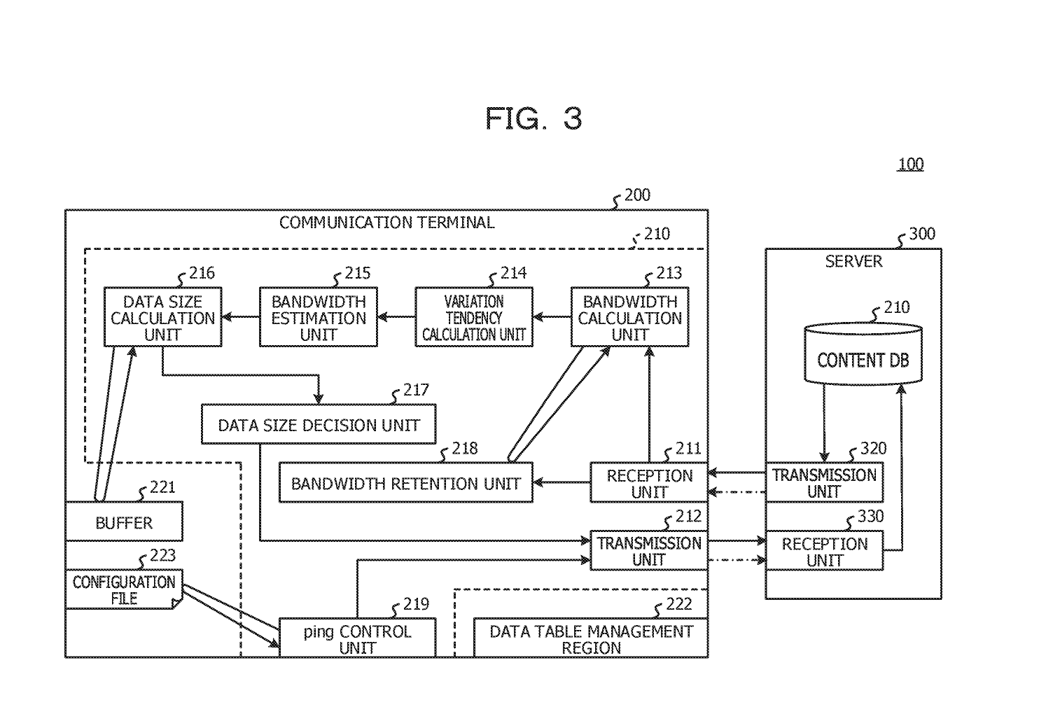

FIG. 3 illustrates functions of the communication terminal. The communication processing unit 210 of the embodiment includes a reception unit 211, a transmission unit 212, a bandwidth calculation unit 213, a variation tendency calculation unit 214, a bandwidth estimation unit 215, a data size calculation unit 216, a data size decision unit 217, a bandwidth retention unit 218, and a ping control unit 219. The communication processing unit 210 of the embodiment implements a function of each unit described above by causing the arithmetic processing device 26 of the communication terminal 200 to execute a communication program.

Furthermore, a buffer 221 is a storage region in which data to be transmitted and received is temporarily stored. A data table management region 222 is a storage region in which a data table 230 to be described is stored. The buffer 221 and the data table management region 222 of the embodiment are provided in, for example, the memory device 25 or the like. A configuration file 223 may also be stored in the memory device 25. The configuration file 223 is a file in which a size of ping data or the like to be described is stored.

Furthermore, the server 300 of the embodiment includes the content database 310, a transmission unit 320, and a reception unit 330.

In the communication terminal 200 of the embodiment, the reception unit 211 receives various pieces of data transmitted from the server 300. The transmission unit 212 transmits various pieces of data from the communication terminal 200 to the server 300.

The bandwidth calculation unit 213 calculates a usable network bandwidth based on responses to ping data. The variation tendency calculation unit 214 calculates a variation tendency of the usable network bandwidth. In response to the variation tendency of the usable network bandwidth, the bandwidth estimation unit 215 estimates a network bandwidth to be usable in subsequent communication.

The data size calculation unit 216 calculates a size of data to be received by the communication terminal 200 from the server 300. In response to a result of the calculated size of the data, the data size decision unit 217 decides on a data size of which the server 300 is notified.

The bandwidth retention unit 218 retains the bandwidth calculated by the bandwidth calculation unit 213. The ping control unit 219 passes ping data of a size stored in the configuration file 223 to the transmission unit 212.

The transmission unit 320 of the server 300 transmits data of a size requested from the communication terminal 200 to the communication terminal 200. The transmission unit 320 also transmits a response to ping data received from the communication terminal 200.

The reception unit 330 of the server 300 receives ping data from the communication terminal 200. The reception unit 330 also receives a notification of a data size of data to be transmitted to the communication terminal 200.

Next, operations performed by the communication terminal 200 of the embodiment will be described.

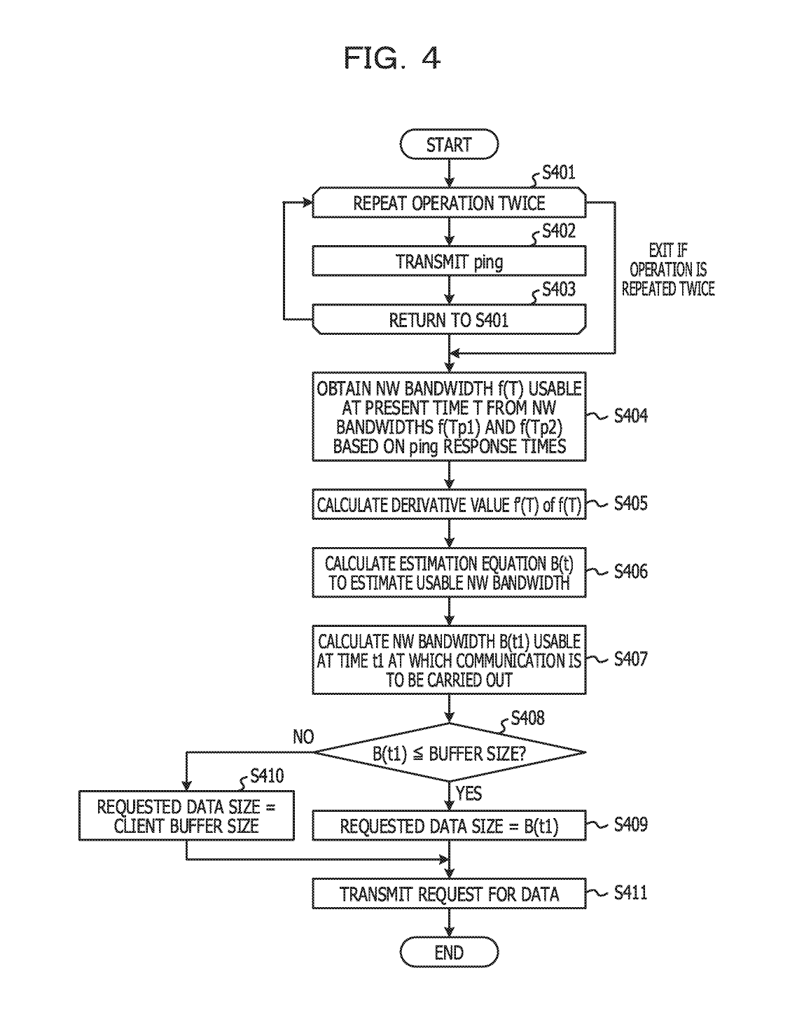

Next, operations performed by the communication terminal 200 of the embodiment will be described with reference to FIG. 4. FIG. 4 is a flowchart illustrating operations performed by the communication terminal. A process illustrated in FIG. 4 is implemented by causing the arithmetic processing device 26 of the communication terminal 200 to execute a communication program.

The communication terminal 200 of the embodiment starts an operation of step S402 by using the ping control unit 219 and the transmission unit 212, and exits to step S404 if the operation of step S402 is repeated twice (step S401). The ping control unit 219 passes ping data of a data size set in the configuration file 223 to the transmission unit 212, and the transmission unit 212 transmits the ping data to the server 300 (step S402). It is noted that the communication terminal 200 retains a time at which ping data is transmitted to the server 300 and a time at which a response to the ping data is received from the server 300. Subsequently, the communication terminal 200 returns to step S401 (step S403).

Next, the communication terminal 200 calculates a network bandwidth f(T) usable at a present time T by using the bandwidth calculation unit 213 (step S404). The operation of step S404 will be further described below.

The bandwidth calculation unit 213 of the embodiment calculates a time period from a time at which ping data is transmitted to a time at which a response to the ping data is received, that is, a response time to the ping data. In the following description, a response time to ping data is referred to as a ping response time.

The bandwidth calculation unit 213 of the embodiment calculates a network bandwidth f(Tp1) from a ping response time Tp1 for first ping data transmission, and calculates a network bandwidth f(Tp2) from a ping response time Tp2 for second ping data transmission. Then, the network bandwidth f(T) usable at the present time T is calculated from these two network bandwidths.

The network bandwidths f(Tp1) and f(Tp2) are calculated using the following equations (1).

f(Tp1)=(first transmitted ping data size [KB]×2)/Tp1 [ms]

f(Tp2)=(second transmitted ping data size [KB]×2)/Tp2 [ms] equations (1)

In the embodiment, for example, assuming that a time at which a response to first transmitted ping data is received is tp1, a network bandwidth usable at the time tp1 may be f(Tp1). Similarly, in the embodiment, assuming that a time at which a response to second transmitted ping data is received is tp2, a network bandwidth usable at the time tp2 may be f(Tp2).

The bandwidth calculation unit 213 calculates the network bandwidth f(T) usable at the present time T from (tp1, f(Tp1)) and (tp2, f(Tp2)). At this time, the network bandwidth f(T) is represented by a linear function. The calculated network bandwidth f(T) is retained by the bandwidth retention unit 218.

Next, the communication terminal 200 calculates a derivative value f′(T) of the network bandwidth f(T) by using the variation tendency calculation unit 214 (step S405). The derivative value f′(T) is represented by the following equation (2).

f′(T)=df(T)/dt equation (2)

The derivative value f′(T) is a value representing a slope of the network bandwidth f(T) at the present time T. Hence, this derivative value f′(T) is a value representing a variation tendency of the network bandwidth f(T). That is, ping data in the embodiment is a control signal transmitted from the communication terminal 200 to the server 300, which is a communication destination of the communication terminal 200, in order that a variation tendency of a network bandwidth may be calculated.

Next, the communication terminal 200 calculates an estimation equation B(t) to estimate a usable network bandwidth by using the bandwidth estimation unit 215 (step S406). The estimation equation B(t) is represented by the following equation (3).

B(t)=f′(T)×(t−T)+f(T) equation (3)

Subsequently, the communication terminal 200 calculates, by using the data size calculation unit 216, a network bandwidth B(t1) estimated to be usable at a time t1 at which communication is to be carried out from the equation (3) (step S407). The network bandwidth B(t1) is represented by the following equation (4).

B(t1)=f′(T)×(t1−T)+f(T) equation (4)

In the embodiment, it is estimated that a data size which is transmitted in one second using the network bandwidth B(t1) is an optimal size which is able to be transmitted from the server 300 to the communication terminal 200 at the time t1.

Next, the communication terminal 200 determines, by using the data size decision unit 217, whether or not a size of the buffer 221 included in the communication terminal 200 is not less than a data size which is able to be transmitted using the network bandwidth B(t1) (step S408).

In step S408, if the size of the buffer 221 is not less than the data size which is able to be transmitted using the network bandwidth B(t1), the data size decision unit 217 decides on the data size which is able to be transmitted in one second using the network bandwidth B(t1) as a requested data size (step S409).

In step S408, if the size of the buffer 221 is less than the data size which is able to be transmitted using the network bandwidth B(t1), the data size decision unit 217 decides on the size of the buffer 221 as a requested data size (step S410).

In the embodiment, in this way, the smaller of a data size which is able to be transmitted in the network bandwidth B(t) and a size of the buffer 221 is decided on as a requested data size. Hence, in the embodiment, data of a size not less than a data size which is able to be transmitted may be kept from being transmitted, and the occurrence of congestion may be suppressed.

Subsequently, the transmission unit 212 transmits an acquisition request for data of the data size decided on by the data size decision unit 217 to the server 300 (step S411), and the process ends.

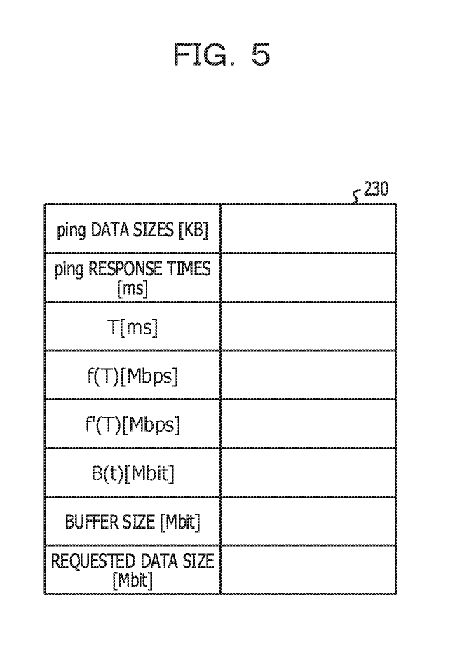

In the embodiment, various pieces of data and a network bandwidth which are used in the process illustrated in FIG. 4 are stored in the data table 230. FIG. 5 illustrates an example of the data table.

The data table 230 of the embodiment contains information items: two ping data sizes, two ping response times, a present time T, a network bandwidth f(T), a derivative value f′(T), an estimation equation B(t), a size of the buffer 221, and a requested data size. The communication terminal 200 stores values corresponding to the items in the data table 230 every time the process illustrated in FIG. 4 is executed.

Every time the communication terminal 200 of the embodiment accepts an acquisition request for data, the communication terminal 200 executes the process illustrated in FIG. 4, and transmits an acquisition request for data and a requested data size to the server 300.

Furthermore, every time the process illustrated in FIG. 4 is executed, the communication terminal 200 of the embodiment overwrites values of the items of the data table 230 illustrated in FIG. 5.

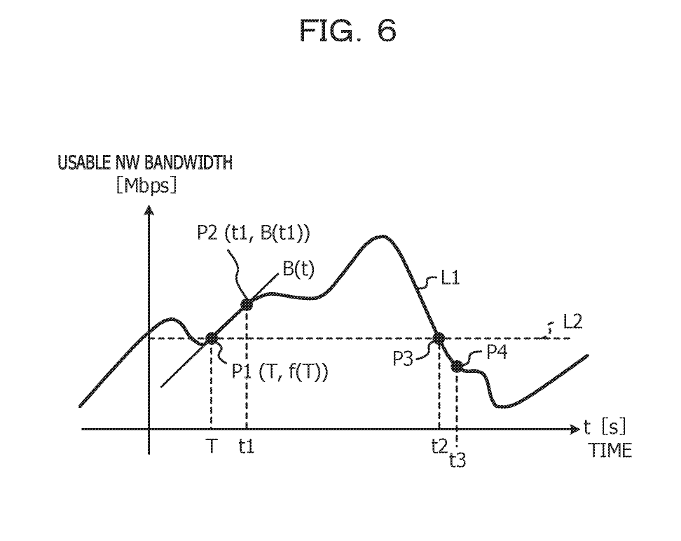

Next, the operations performed by the communication terminal 200 of the embodiment will be further described with reference to FIG. 6. FIG. 6 illustrates variations in usable network bandwidth.

In FIG. 6, the horizontal axis represents time, and the vertical axis represents network bandwidth. In FIG. 6, a curve L1 indicated by a solid line represents a usable network bandwidth, and a point P1 represents a network bandwidth f(T) usable at a time T. Furthermore, in FIG. 6, a straight line L2 indicated by a dotted line represents a network bandwidth used in communication in the case where a requested data size is a fixed data size. In the case where a requested data size is a fixed data size, a network bandwidth used in communication is found to be fixed.

In the embodiment, a function B(t) representing a tangent to the curve L1 at the point P1 is obtained from a derivative value f′(T) of the network bandwidth f(T) represented by a linear function. The derivative value f′(T) represents a slope of the network bandwidth f(T) at the point P1, that is, a variation tendency of the network bandwidth.

In the embodiment, the function B(t) is an estimation equation to calculate an estimation value of a network bandwidth usable at a time t.

In the embodiment, for example, when the communication terminal 200 makes an acquisition request for data to be transmitted from the server 300 immediately before a time t1, the communication terminal 200 calculates, by using the estimation equation B(t), a network bandwidth B(t1) usable at the time t1 at which communication is actually to be carried out.

A point P2 illustrated in FIG. 6 represents the network bandwidth B(t1) estimated to be usable at the time t1 which has been obtained as described above.

In FIG. 6, the estimation equation B(t) is a monotonically increasing function with a positive slope. Hence, a value of the network bandwidth B(t1) at the time t1 is larger than a value of the network bandwidth f(T) at the time T.

In the embodiment, when a data size which is able to be transmitted using the network bandwidth B(t1) is decided on as a requested data size at the time t1, more data may be acquired at once than when communication is continuously carried out using the network bandwidth f(T), thereby enabling a reduction in time spent on communication.

Furthermore, in FIG. 6, the estimation equation B(t) at a point P3 representing a network bandwidth f(t2) at a time t2 is a monotonically decreasing function with a negative slope. Hence, a value of a network bandwidth B(t3) at a time t3 is smaller than a value of a network bandwidth B(t2) at the time t2.

In the embodiment, when a data size which is able to be transmitted using the network bandwidth B(t3) is decided on as a requested data size at the time t3, congestion occurring in the case where communication is continuously carried out using the network bandwidth B(t2) may be blocked.

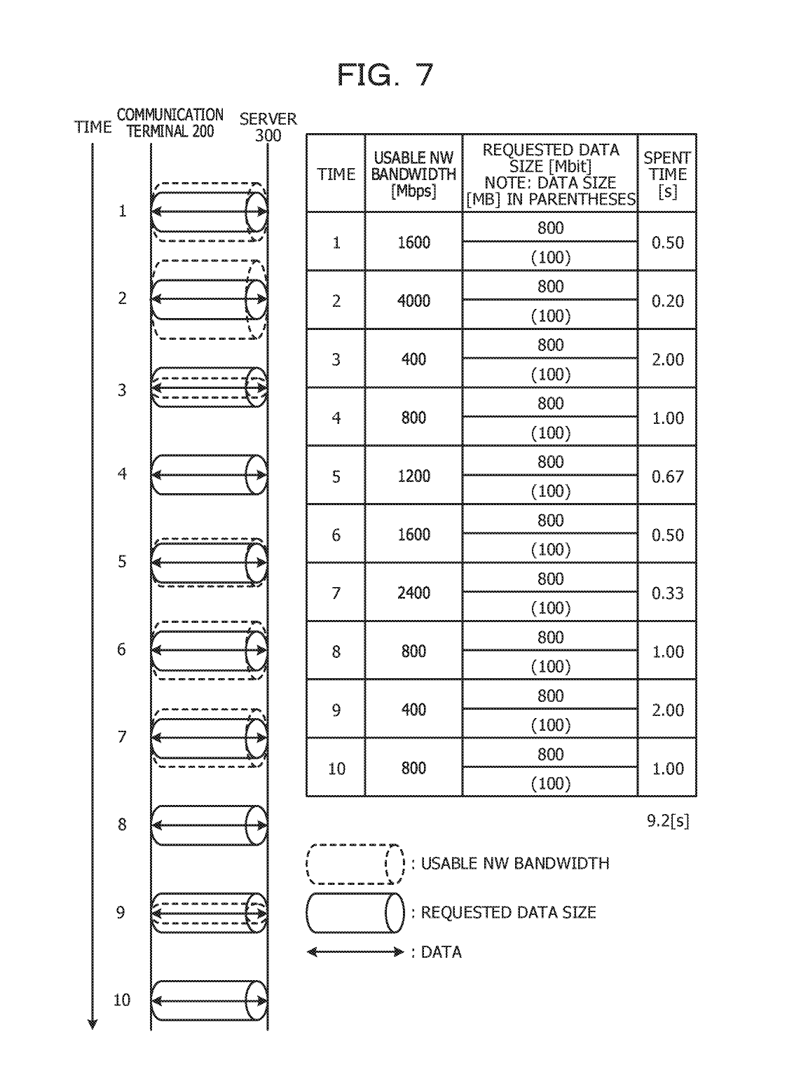

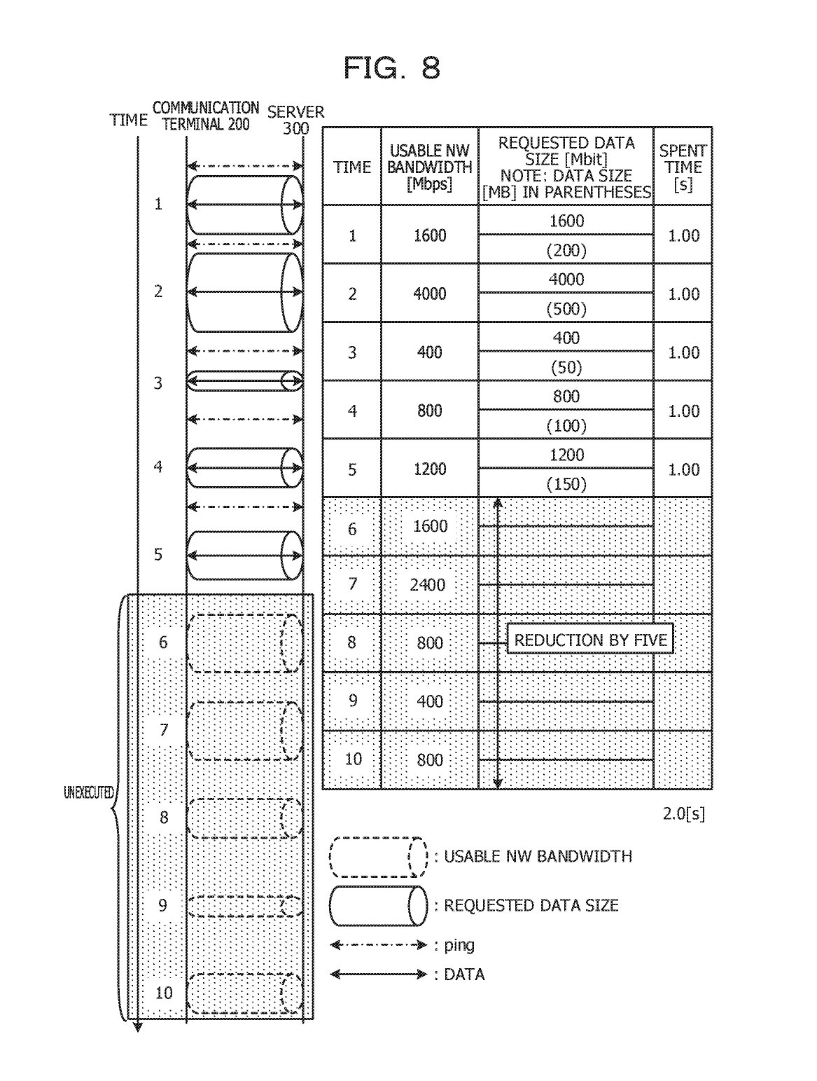

The effect of the embodiment will be further described below with reference to FIG. 7 and FIG. 8. FIG. 7 illustrates a comparative example for illustrating the effect of the embodiment. FIG. 8 illustrates the effect of the embodiment. In FIG. 7 and FIG. 8, among cylindrical figures coupling the communication terminal 200 to the server 300, figures indicated by solid lines each represent a requested data size transmitted from the communication terminal 200 to the server 300, and figures indicated by dotted lines each represent a usable network bandwidth. Furthermore, solid double-headed arrows in FIG. 7 and FIG. 8 each represent the transmission and reception of data, and dotted double-headed arrows in FIG. 8 each represent the transmission and reception of ping data.

FIG. 7 illustrates the case where transmission and reception is performed with a fixed data size when a requested data size is 800 Mbit regardless of a network environment.

In the example in FIG. 7, for example, communication has to be carried out ten times before the transmission and reception of a file of 1 GB is completed. Additionally, in the example in FIG. 7, although usable network bandwidths are each less than 800 Mbps at a time 3 and a time 9, the transmission and reception of data is attempted with an unchanged size of 800 Mbit, which is the requested data size, and thus congestion occurs and has adverse effects on other communication. Furthermore, in the example in FIG. 7, although usable network bandwidths are each not less than 800 Mbps at a time 1 and a time 2, the transmission and reception of data is attempted with an unchanged size of 800 Mbit, which is the requested data size, and thus excessive time is spent on communication.

On the other hand, in an example in FIG. 8, in order that transmission and reception may be performed with a maximum data size available in a usable network bandwidth, a network bandwidth for subsequent communication is estimated from a derivative value (slope) of the usable network bandwidth calculated by using ping response times. Then, in the embodiment, a data size responsive to the estimated network bandwidth is decided on as a requested data size.

Specifically, for example, in the example in FIG. 8, it is found that a data size is increased at the time 2 and is reduced at the time 3 in accordance with respective usable network bandwidths.

As a result, in the example of FIG. 8, the number of times communication has to be carried out before the transmission and reception of a file of 1 GB is completed is five, and thus the transmission and reception may be completed when communication is carried out five fewer times than ten times illustrated in FIG. 7.

Hence, according to the embodiment, communication efficiency may be improved.

Although the above-described embodiment describes the case where the communication terminal 200 receives data from the server 300 as an example, it is noted that the embodiment is not limited to this. The process performed by the communication processing unit 210 of the embodiment may be performed when data is transmitted from the communication terminal 200 to the server 300.

In this case, the communication processing unit 210 transmits data of a data size decided in response to an estimated network bandwidth to the server 300.

Furthermore, although the communication processing unit 210 is provided in the communication terminal 200 in the embodiment, the embodiment is not limited to this. For example, the communication processing unit 210 may be provided in the server 300. In this case, when the server 300 carries out communication, the server 300 decides on a data size responsive to an estimated network bandwidth, and transmits data of this data size.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication apparatus comprising:
a memory; and
a processor coupled to the memory and configured to
calculate, based on a bandwidth variation tendency of a calculated network bandwidth between the communication apparatus and other communication apparatus, a usable network bandwidth at a transmission time at which the other communication apparatus transmits data,
determine, based on the usable network bandwidth, a size of the data to be transmitted,
inform the other communication apparatus of the size of the data, and
receive the data of the size from the other communication apparatus at the transmission time.

2. The communication apparatus according to claim 1,
wherein the processor is configured to calculate the variation tendency by performing
a first transmission of a first control signal to the other communication apparatus at a first time before the transmission time, and a calculation of a first network bandwidth based on a first response time to the first control signal,
a second transmission of a second control signal to the other communication apparatus at a second time before the transmission time, and a calculation of a second network bandwidth based on a second response time to the second control signal, and
a calculation of the variation tendency of the network bandwidth based on the first network bandwidth and the second network bandwidth.

3. The communication apparatus according to claim 2,
wherein the usable network bandwidth is calculated based on the variation tendency of the calculated network bandwidth and the transmission time.

4. The communication apparatus according to claim 1, further comprising:
a data buffer configured to store the data,
wherein the processor is configured to
compare a size of the data buffer with the determined size of the data to be transmitted using the usable network bandwidth, and
when the size of the data buffer is less than the determined size of the data to be transmitted using the usable network bandwidth, adjust the determined size of the data to the size of the data buffer.

5. The communication apparatus according to claim 1,
wherein the processor is configured to
inform the other communication apparatus of the determined size of the data and an acquisition request for the data to be transmitted at the subsequent time.

6. A communication system comprising:
a first communication apparatus; and
a second communication apparatus,
wherein the first communication apparatus includes
a memory, and
a processor coupled to the memory and configured to
calculate, based on a bandwidth variation tendency of a calculated network bandwidth between the communication apparatus and other communication apparatus, a usable network bandwidth to be usable at a transmission time at which the other communication apparatus transmits data, determine, based on the usable network bandwidth, a size of data to be transmitted,
inform the second communication apparatus of the size of the data, and
receive the data of the size from the second communication apparatus at the transmission time.

7. The communication system according to claim 6,
wherein the processor is configured to calculate the variation tendency by performing
a first transmission of a first control signal to the second communication apparatus at a first time before the transmission time, and a calculation of a first network bandwidth based on a first response time to the first control signal,
a second transmission of a second control signal to the second communication apparatus at a second time before the transmission time, and a calculation of a second network bandwidth based on a second response time to the second control signal, and
a calculation of the variation tendency of the network bandwidth based on the first network bandwidth and the second network bandwidth.

8. The communication system according to claim 7,
wherein the usable network bandwidth is calculated based on the variation tendency of the calculated network bandwidth and the transmission time.

9. The communication system according to claim 6, wherein the first communication apparatus further comprises a data buffer configured to store the data,
wherein the processor is configured to
compare a size of the data buffer with the determined size of the data to be transmitted using the usable network bandwidth, and
when the size of the data buffer is less than the determined size of the data to be transmitted using the usable network bandwidth, adjust the determined size of the data to the size of the data buffer.

10. The communication system according to claim 6,
wherein the processor is configured to
inform the second communication apparatus of the determined size of the data and an acquisition request for the data to be transmitted at the time.

11. A communication method using a first communication apparatus and a second communication apparatus, the communication method comprising:
calculating, based on a bandwidth variation tendency of a network bandwidth between the first communication apparatus and the second communication apparatus, the network bandwidth to be usable at a transmission time at which the second communication apparatus transmits data;
determining, based on the usable network bandwidth, a size of the data to be transmitted;
informing the second communication apparatus of the size of the data; and
receiving data of the size from the second communication apparatus at the transmission time.

12. The communication method according to claim 11, further comprising:
transmitting a first control signal to the second communication apparatus at a first time before the transmission time;
calculating a first network bandwidth based on a first response time to the first control signal;
transmitting a second control signal to the second communication apparatus at a second time before the transmission time;
calculating a second network bandwidth based on a second response time to the second control signal; and
calculating the variation tendency of the network bandwidth based on the first network bandwidth and the second network bandwidth.

13. The communication method according to claim 12,
wherein the usable network bandwidth is calculated based on the variation tendency of the calculated network bandwidth and the transmission time.

14. The communication method according to claim 11, wherein the first communication apparatus includes a data buffer configured to store the data, the method further comprising:
comparing a size of the data buffer with the determined size of the data to be transmitted using the usable network bandwidth; and
when the size of the data buffer is less than the determined size of the data to be transmitted using the usable network bandwidth, adjusting the determined size of the data to the size of the data buffer.

15. The communication method according to claim 11, further comprising:
informing the second communication apparatus of the determined size of the data and an acquisition request for the data to be transmitted at the time.
